(19) United States
(12) Patent Application Publication
(10) Pub. No.: US 2004/0267616 A1
(43) Pub. Date: Dec. 30, 2004

(54) Creation of custom designed direct mail advertising via the internet

(76) Inventor: James B. Kargman, Chicago, IL (US)

Correspondence Address: Greenberg Traurig, LLP, Suite 2500, 77 West Wacker Drive, Chicago, IL, 60601, US

(21) Appl. No.: 10/831,061

(22) Filed: Apr. 23, 2004

Related U.S. Application Data
(63) Continuation of application No. 09/913,198, filed on Jan. 7, 2002, now abandoned.

(30) Foreign Application Priority Data
Feb. 11, 2000 (WO) PCT/US00/03480

(51) Int. Cl. G06F 17/60

(52) U.S. Cl. 705/14

(57) ABSTRACT

A method for creating a custom designed direct mail advertisement and designating recipients thereof via the Internet comprising the steps of: logging on to a web site via the Internet (100); selecting one of one or more pre-defined designs for the front side of a direct mail advertisement (120); selecting one of one or more predefined templates for the back side of a direct mail advertisement (150); specifying text that appears on the back side of a direct mail advertisement (160); specifying criteria that define the intended recipient class; compiling a list of recipients by searching a database for names and addresses that match the specified criteria; and transmitting the design of the front and back sides of the direct mail advertisement and the list of intended recipients toward printing pre-addressed individual copies of the designed direct mail advertisement for subsequent mailing to the intended recipients thereof.

### BACKGROUND OF THE INVENTION

1. The Technical Field

The present invention relates generally to the design, printing and mailing of direct mail pieces to actual and or potential customers for the products or services being offered by a business. In particular, the present invention relates to an automated system for designing, addressing, printing and mailing a direct mail piece via an Internet-based user interface.

2. Background

Specifically disclosed herein is a system for permitting a user to custom design a direct mail advertising piece and select intended recipients using the Internet towards executing a highly effective, focused and accountable direct mail advertising campaign targeting a specific audience, thereby maximizing the use of advertising dollars.

The present system does away with the need to spend time and money retaining separate graphic artists, copyrighters, computer technicians, printers and address list vendors and provides a one stop solution to creating, customizing, printing and mailing high quality customized direct mail advertising pieces. The present system provides for the design of both graphic and textual matter included on the direct mail piece, the generation of a targeted mailing list, the determination of the actual cost for executing the direct mail piece prior to confirming the order, the printing of the direct mail piece, and the mailing of same to the intended recipients.

In the prior art, to prepare, produce and distribute a direct mail piece, a business owner typically has to spend significant time and effort to design both the appearance as well as the textual content which would appear on the printed advertisement to be mailed to addressed recipients. A direct mail piece typically comprises a single two sided unfolded card having a dimension nominally equal to 8 by 6 inches. One face of the piece typically contains an advertisement, promotion or the like being offered by the business while the other side, in addition to containing further promotional information, contains the address to whom the direct mail piece is to be delivered via the postal service.

The prior art process of producing a direct mail piece typically begins with designing exactly what is going to appear on each face of the piece. Significant time and effort is required by the business to not only create the actual message which is going to be delivered but more importantly to lay out the message in an appealing format on the face of the card so as to have a professional appearance which would attract actual and potential customers to the business. Great effort is typically required to create a promotion piece which distinguishes itself from other mass mail pieces which are typically received by a homeowner through the mail. Accordingly, graphic artists are often retained at great expense to create attractive artwork to appear on one face of the piece which is intended to catch the recipient's attention and cause him or her to read the piece and see the business' advertisement or offer.

Once the piece is designed the business owner typically must retain the services of a printer to actually print the cards in a quantity sufficient for the mailing. Equally if not more important is the step of determining to whom the direct mail piece is going to be mailed. A business typically utilizes its own preexisting mailing list which comprises the names and addresses of present or former customers of the business. In some cases the mailing list may also include names and addresses which were purchased or acquired from outside sources. Typically the address list maintained by a small to medium size business is relatively unsophisticated in the sense that it may not accurately and efficiently target in an efficient manner those individuals most likely to purchase the goods or services being offered by business. Moreover, the use of such preexisting mail lists as maintained by the businesses themselves are typically dated and typically contain the names and address of individuals who no longer reside at the addresses contained in the database such that the expense incurred in producing and mailing a piece to those individuals is wasted.

Moreover, businesses typically sort and maintain their mailing lists in zip code order, sometimes alphabetized by zip code, and sometimes on computer. A business may choose to select addresses within a given zip code by either printing labels or generating a computer file containing the addresses within that particular zip code. However, should the business wish to target its mailing in a more sophisticated manner, a great deal of effort is required—an effort which is typically unsuccessful given the manner in which the data is maintained by the business. For example, a business that delivers product directly to the consumer, such as a pizza restaurant may very well wish to target its promotion in a very narrow geographic region, moving from region to region with each successive promotion so that the business' delivery people are not required to drive crisscross all over town, but rather, can concentrate their delivery efforts in fulfilling orders being generated from a particular neighborhood or consolidated region.

Conversely, a business may wish to distribute a direct mail piece to recipients in a uniform manner which would results in mailings being generated to only a portion of the individuals residing within a given zip code range. For the business to effectively execute such a promotional program it is necessary to not only identify to whom within each zip code direct mail pieces have been mailed, but more importantly, to identify and track those to whom a piece has not been mailed so that successive mailings may target up those individuals. Obviously the time and effort required to execute such a sophisticated program may well be beyond the means or skills of a typical small business whose resources may be otherwise required to address the on going basic operation of the business and are not available for customized promotional campaigns.

Additionally, after the direct mail pieces have been printed, and after they have been addressed (either by the printer or by the business itself using either direct printing methods or paste on labels) the pieces must be bundled for the delivery to the postal service for delivery to the recipient. Discounts are available from the postal service based upon the degree to which the direct mail pieces have been previously sorted, with the best rate often available only by sorting mail by carrier route or the like. Again, the manner in which a typical small business maintains its address database does not lend itself to automatic sorting and instead requires that manual sorting be used, which is often not feasible.

The present invention seeks to address each of the foregoing short comings and disadvantages and offer further benefits to both small and large businesses alike who wish to design, print and mail customized direct mail pieces.

Accordingly it is an object of the present invention to permit the user to create and address and to control and command the printing and distribution of direct mail pieces over the Internet.

It is another object of the present invention to obviate the need to seek out the services of multiple third parties to create, address, print and distribute a direct mail piece.

A further object of the present invention is to provide the user with a head start in creating a direct mail piece by offering the user the ability to choose from among pre-designed elements of artwork which may be selected for printing on the direct mail piece.

Yet another object of the present invention is to provide the user access to preexisting templates which serve to format the textual content composed by the user for printing on the direct mail piece.

A still further object of the present invention is to provide for the creation of a direct mail piece which contains a coupon redeemable by the recipient as well as a textual explanation of the offer or other promotional content relating to the business.

Another object of the present invention is to provide the user with the ability to access preexisting address databases and/or use the business' own mailing lists to select recipients of the direct mail piece.

A still further object of the present invention is to provide the user with the ability to select recipients of the direct mail piece by absolute location, by geographic proximity to the user's business, by demographic profile, or by randomly selected subsets within a category on a rotating periodic basis.

A further object of the present invention is to provide for the printing and sorting of the direct mail piece in a manner which minimizes postage costs.

These and other objects of the present invention will become apparent to those of ordinary skill in the art in light of the present specifications, drawings and claims.

### SUMMARY OF THE INVENTION

The present invention discloses a method for creating a custom designed direct mail advertisement and designating recipients thereof via the Internet. The method begins with the step of logging on to a web site via the Internet. Once logged in the user selects from among one or more pre-defined designs a design for the front side of a direct mail advertisement. The user then selects from among one or more predefined templates a design for the back side of a direct mail advertisement. The text that appears on the back side of a direct mail advertisement is then specified. Next one or more criteria that define the intended recipient class for the direct mail advertisement are specified. The list of recipients for the direct mail advertisement corresponding to the specified criteria is then compiled. Thereafter, data files comprising the design of the front and back sides of the direct mail advertisement and the list of recipients are electronically transmitted toward printing pre-addressed individual copies of the custom designed direct mail advertisement for subsequent mailing to the intended recipients thereof.

One embodiment of the invention further includes the step of selecting a theme for the direct mail piece from one or more themes with each theme having associated therewith one or more pre-defined designs for the front side of the direct mail advertisement.

The step of specifying one or more criteria that define the intended recipient class for the direct mail advertisement may comprise the step of entering the name and addresses for each intended recipient of the direct mail piece. Alternatively, the step of specifying one or more criteria that define the intended recipient class for the direct mail advertisement may comprise the step of specifying a starting address and a distance therefrom toward identifying the intended recipients of the direct mail piece. Still further the step of specifying one or more criteria that define the intended recipient class for the direct mail advertisement further comprises the step of searching a database corresponding to names and addresses using the specified criteria toward identifying the name and address for each intended recipient of the direct mail piece.

The step of specifying one or more criteria that define the intended recipient class for the direct mail advertisement may include the step of entering one or more demographic criteria associated with the names and addresses maintained by a database toward identifying intended recipients of the direct mail piece while the step of specifying one or more criteria that define the intended recipient class for the direct mail advertisement may comprise the step of transferring a pre-existing database list of names and addresses for the intended recipients of the direct mail piece.

The invention further includes the step of presenting to the user the total maximum cost for placing an order for the production and mailing of the direct mail pieces prior to the user confirming the order.

In one embodiment the method for creating a custom designed direct mail advertisement and designating recipients thereof via the Internet comprises the steps of: logging on to a web site via the Internet; selecting from among one or more pre-defined designs a design for the front side of a direct mail advertisement; selecting from among one or more predefined templates a design for the back side of a direct mail advertisement; specifying the text that appears on the back side of a direct mail advertisement; specifying one or more criteria that define the intended recipient class for the direct mail advertisement; compiling the list of recipients for the direct mail advertisement corresponding to the specified criteria by searching a database for names and addresses that match the specified criteria; and transmitting the design of the front and back sides of the direct mail advertisement and the list of intended recipients of same toward for printing pre-addressed-individual copies of the designed direct mail advertisement for subsequent mailing to the intended recipients thereof.

### BRIEF DESCRIPTION OF THE DRAWINGS

FIG. 1 of the drawings illustrates one face of a direct mail piece created using the present Invention specifically illustrating the artwork relating to the theme selected by the user;

FIG. 2 of the drawings illustrates the other face of a direct mail piece created using the present invention specifically illustrating a template completed by the user toward conveying an advertisement and offer to the recipient;

FIGS. 3a and 3b of the drawings are a flowchart of the process by which a user creates and addresses and controls the printing and distribution of a direct mail piece via the Internet according to the present invention;

FIG. 4 of the drawings illustrates the text boxes containing sample text providing suggested language for the direct mail piece;

FIG. 5 of the drawings illustrates the completed second face of the direct mail piece presented to the user for approval; and

FIG. 6 of the drawings illustrates the input screen presented by the system to the user for specifying the demographic criteria to be used to identify intended recipients of the direct mail piece.

### DETAILED DESCRIPTION OF THE DRAWINGS

While this invention is susceptible to embodiment in many different forms, there are shown in the drawings and will be described in detail herein several specific embodiments. The present disclosure is to be considered as an exemplification of the principle of the invention intended merely to explain and illustrate the invention, and is not intended to limit the invention in any way to embodiments illustrated.

Rather than having to individually seek out each of the different third parties whose skills are necessary to create, produce, address and distribute a direct mail piece, the present invention provides the user with a one stop shop via the Internet, or other computer network, to implement and execute a direct mail campaign. For purposes of the present disclosure a direct mail piece for a pizzeria is illustrated with the understanding that the present invention is suitable for use by virtually any business.

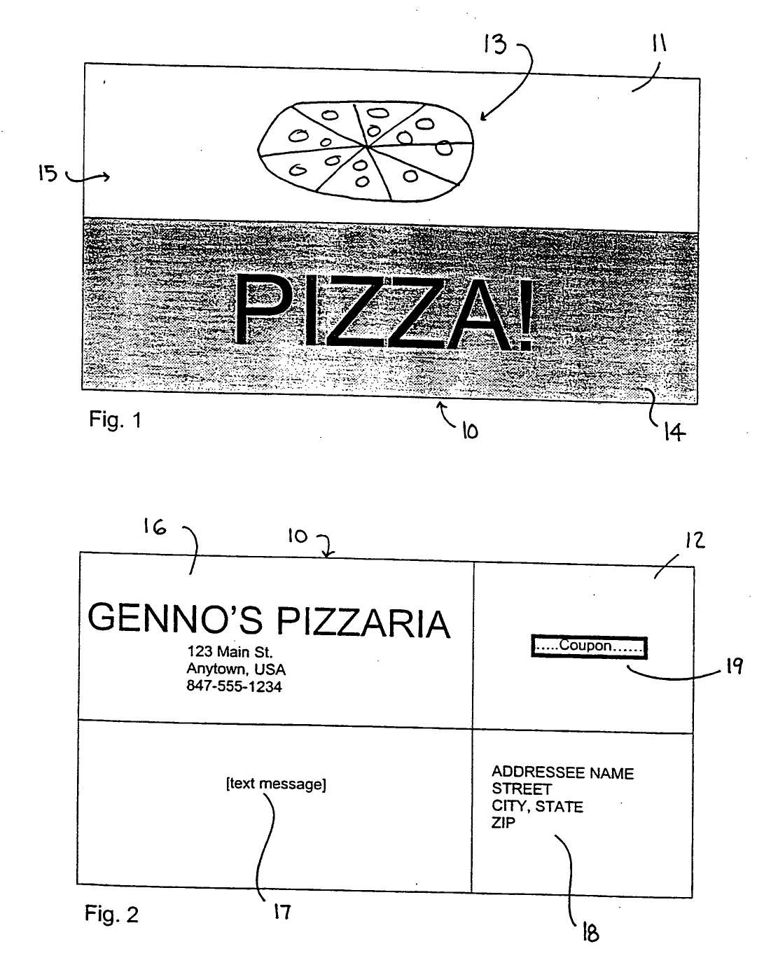

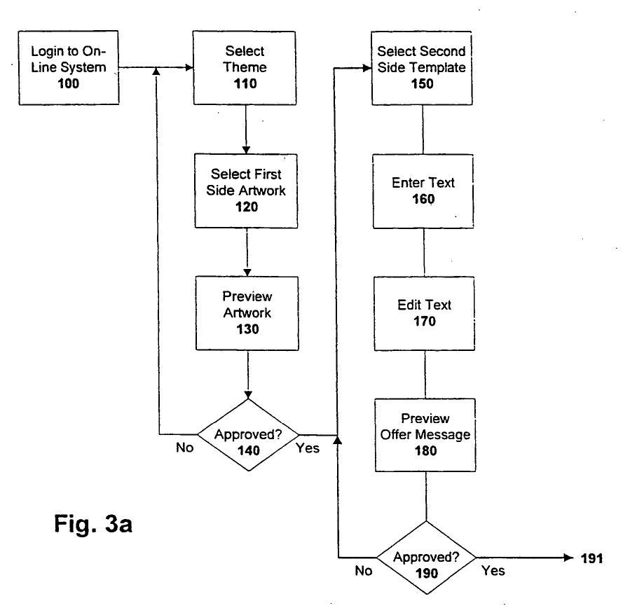

FIGS. 1 and 2 of the drawings illustrate the two sides of a sample direct mail piece 10 created using the present invention. The sample illustrated is shown as having been created and tailored specifically for a pizzeria business. FIG. 1 of the drawings illustrates one side 11 of a sample direct mail piece 10. In the example illustrated face 11 is shown as containing artwork 15 which includes a text component 14 at the lower half of the card and an graphic component 13 on the upper half of the card. As explained further herein, side 11 may be configured to present different artwork as selected by the user. The recipient of this direct mail piece readily sees that an advertisement or offer relating somehow to pizza is being presented.

FIG. 2 of the drawings illustrates the opposing side 12 of the sample direct mail piece 10. On side 12 the name, address and phone number of the business sending the direct mail piece appears in region 16. The name and address of the intended recipient of the direct mail piece appears in region 18 and is positioned so as to facilitate its recognition and delivery by the postal service. A text message appears in region 17 and a coupon in region 19. The text message typically conveys to the recipient additional information about the business or the promotion being advertised. For example, the message may further elaborate on the nature of an ongoing sale or give further detail regarding the coupon appearing in region 19. As disclosed herein, the composition of side 12 may be selected and configured by the user via the Internet and the actual text messages, including particulars relating to the offer and coupon are determined by the user with the system assisting in the formatting of same. The artwork 15 appearing on side 11 of the direct mail piece 10 and the text appearing on side 12 are each selected by the user using the present system.

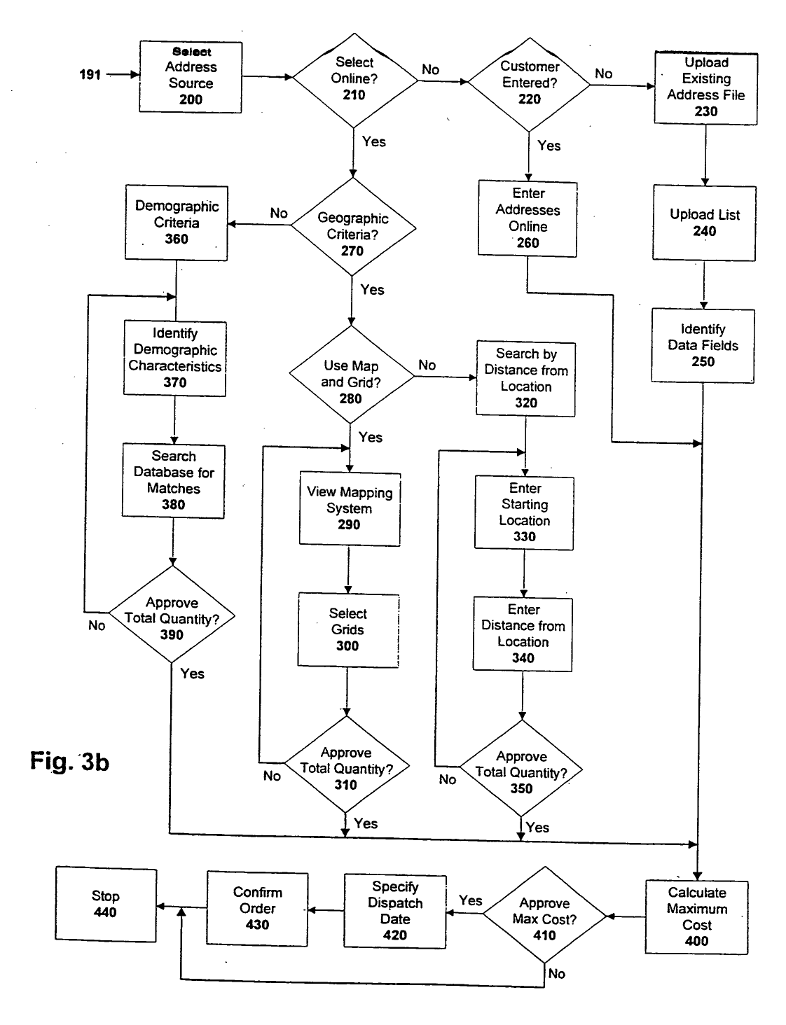

FIGS. 3a and 3b of the drawings illustrate the steps of the method disclosed by the present invention. The underlying software programming details implementing the present invention are known to those of ordinary skill in the art, such as HTML and Java programming, and do not specifically comprise a part of the present invention.

The creation of a direct mail piece begins with the user accessing a web site associated with the presently disclosed system by logging on to the on-line system, step 100. For purposes of this disclosure the web site is referred to as ZIPM.COM which the user may access via the Internet using a web browser program running on a personal computer. Using the present system a small and or large business from a computer desktop may design all facets of a direct mail piece.

Upon accessing the ZIPM.COM web site the user first identifies him or her self to the system by logging in using a pre-assigned login name and password. First time users may be directed to a registration page to enter their name, address and billing information, including credit card data, after which a login name and password are selected and/or assigned. Alternatively and so as not to deter potential users from reviewing the benefit of the system, the user's login and password may be solicited just prior to confirming an order for the production and mailing of a direct mail piece so that the user may view the system and experience the ease of use, power and utility provided thereby without having to register as first. On each login the user may have the opportunity to change billing or personal details.

The system first prompts the user to select a theme for the direct mail piece from among one of several predefined themes, step 110. Each theme page serves to provide the user with a head start in creating a direct mail piece by offering the user the ability to choose from among many pre-designed elements of artwork which may be selected for printing on one-side of the direct mail piece, step 120. The artwork offered is divided into different categories and classifications to permit the user to identify one most suitable for his or her needs, business or customer base. Themes may include topics such as GENERAL, HOLIDAY, SALE and PIZZA, where each theme has multiple choices for cover art associated therewith. Once the theme is chosen the user can choose from among several variations on that theme. The artwork provided to the user comprises high quality graphic designs which have a professional appearance when printed. For example, the PIZZA theme may have five different samples of artwork from which the user may choose. In the example illustrated, a PIZZA theme has been selected and relatively simple artwork chosen. Of course, much more elaborate artwork and themes are possible.

The intent is to offer the business universally appealing concepts toward attracting new and repeat customers to the business. Any business can use any of the themes to prompt interest in a prospect to turn the card over and read the message and/or offer appearing on the other side. For example, a local pizza parlor that wishes to generate a direct mail piece advertising a special promotion can select pre-designed artwork in four color fashion illustrating, for example, a warm pizza being pulled from an oven—all without having to create the piece or identify the artwork and obtain clearance of rights to use same. Once selected, the user may preview the artwork, step 120, and view an enlarged image on screen. Once approved, step 140, the user proceeds to the step of preparing the offer. If the user does not approve the artwork selected, the user may return to step 110 and select another theme or artwork.

The user begins to prepare an offer by choosing a template for the second side of the direct mail piece, step 150. Templates in the present invention comprise pre-defined graphic layouts of offers that are used to present an offer or concept to prospective customers or clients of the business. The system can have a virtually unlimited number of templates available for the user to select from. The template is a pre-designed layout complete with font sizes and organizations all predefined. All the user has to do is select the template layout that he or she prefers and then enter the text into the template text entry regions provided on-screen. Templates may present varying styles, such as contemporary, traditional, classic etc. which may be selected. For example, a furniture store specializing in country designs might prefer a traditional layout and font style while a hair salon may prefer a contemporary font style.

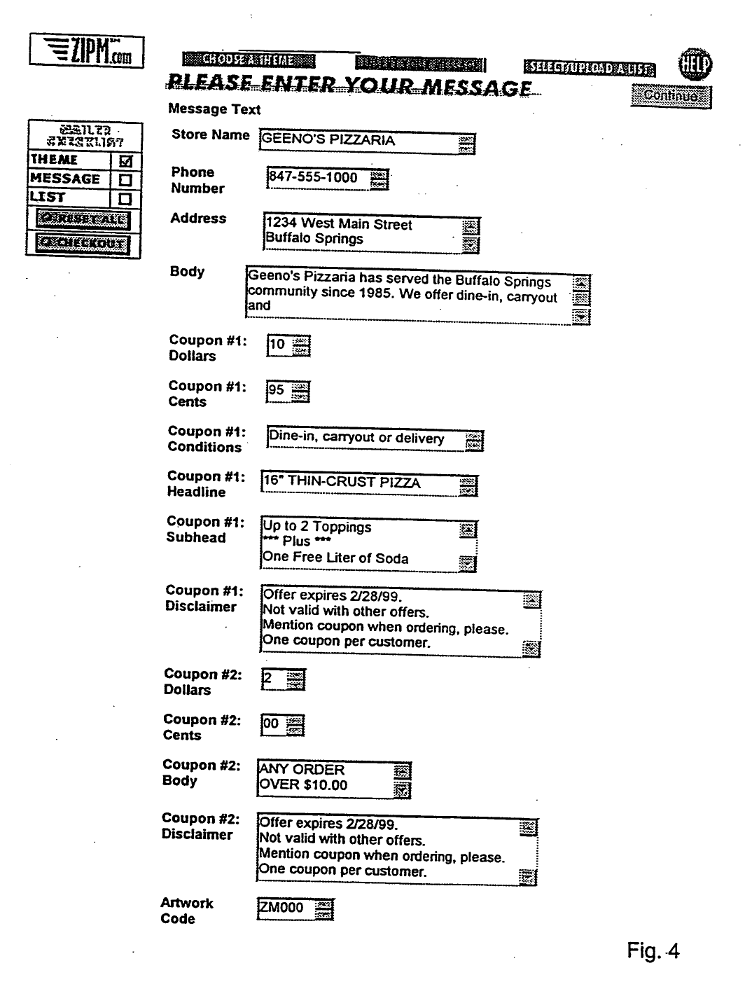

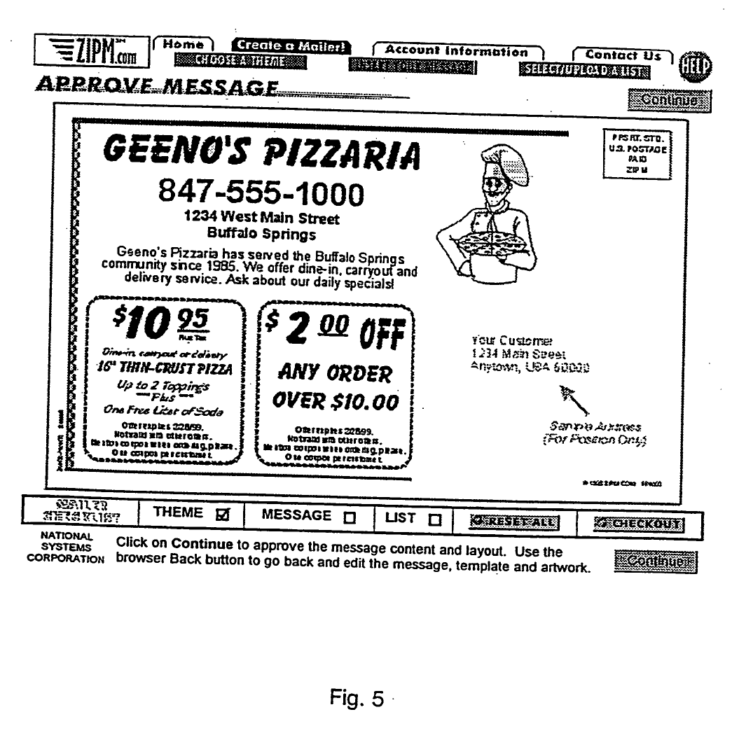

In one embodiment of the present invention the user is presented with blank text boxes in which user composed text is entered. In another embodiment illustrated in FIG. 4 the user is presented with text boxes containing sample text consistent with the theme selected that helps suggest proper wording of an offer. In each case, the user enters text of his or her choosing, step 160. The system automatically sizes the text boxes to guide the user on how may characters are possible on each line, reflecting the actual font size used on the actual direct mail piece thus doing away with the need for graphic artists and designers. The predefined limits imposed by the system ensure that a pleasant attractive looking direct mail piece will be produced. The provision of suggested wording eliminates the need to retain copyrighters to create the text message. The user enters his or her special text or offer after which the system will process the text into an actual display of what the direct mail piece will look like when received by the recipient. The user may edit the text, step 170 and when complete may preview a proof copy of the piece, step 180, illustrated in FIG. 5. The user may approve the text, step 190 or elect to change the text entry by returning to step 150 to select another template. Alternatively the user may return to step 170 and resume editing the text prior to confirm it for printing. The system thus automatically converts the user entered text into a properly formatted direct mail piece.

After preparing and approving the direct mail piece, the user is given the opportunity to select an address source, step 200 from which the user will identify and select the recipients who shall receive the direct mail piece. The user is given three options for selecting an address source.

As one option, step 220, the system permits the user to enter a mailing list of his or her own, addressee by addressee, on-line, step 260. This is useful for a business which may have a mailing list which is not maintained in an electronic format. The user entered list is subsequently maintained by the system for later use by the business. The user may additionally later add, change or delete entries in the mailing list.

As a second option, step 230, the user may upload an existing list maintained by the user in an electronic form, step 240. The system provides tools and utilities to accept the user's format and make it useable by the system. Businesses who have their own mailing lists can transfer them directly to the system by uploading to the ZIPM.COM site. Once the file has been uploaded the business specifies how their file is laid out, step 250. Files can be organized in a number of ways. For example by Name, Address, City, Zip; or by Phone, Address, Name, Zip. The system provides a tool to display to the user the characteristics of the business' uploaded mailing list file so that the user can then identify to the system which of those characteristics correspond with the mailing label characteristics. It is a simple matter of defining for the system a correlation between field locations in the file and positions on the mailing piece. In this manner, the direct mail pieces are properly addressed for postal delivery without having to process and reorganize the entire uploaded database. Moreover, when a user uploads a file, the cost of the mailing can be based on the quantity of addresses uploaded. Since some addresses might be invalid, the quotation may be given as a maximum amount which might be charged to the user's credit card were an order to be confirmed, step 400.

As a third option, step 210, the user may access one or more databases maintained by the system using search tools presented on-screen to the user as the address source. This third option presents to the user a powerful tool for addressing the short comings typically associated with a business's own preexisting database. The user is provided the ability to skillfully and accurately identify specific targeted individuals or entities to whom the direct mail piece should be delivered. The databases accessible to the user contain not only name and addresses but also demographic data corresponding to each name in the database. Commercially available databases may be remotely accessed by the system or internalized into the system toward permitting the user to select addressees for the direct mail piece.

The demographic database may be accessed based upon pure geographic factors, step 270. To compose a mailing list based upon geographic factors, the user is first presented with the choice of using a map and grid, step 280. If selected, the user views a map with a centroid based on an actual street address or zip code provided by the business as a central point of their service or trade boundaries, step 290. The map shown includes a grid overlay which provides a convenient method of selecting targeted quadrants for pinpoint marketing by the business. The user may select one or more grids from the displayed map by checking a list of grid numbers using a mouse, step 300. The system will then present the user with the total the number addresses within the grids selected for the users approval, step 310. If rejected, the user returns to the map and grid to re-select the grids until an acceptable quantity of addresses is obtained. Once approved, the user is presented with a calculation of the total maximum cost which would be incurred if the order is confirmed, step 400. Different offers can be sent to different groups within these differing boundaries by simply creating another offer and target mailing list.

Alternatively, the user is provided the option of searching for addresses which are a specified distance from a given location toward selecting addresses to which the direct mail piece is to be mailed, step 320. The user enters a starting location, step 330 which may be the user's business address, or alternatively may be another address, such as where a pizzeria desires to mail to all addresses within 1 mile of the center of a college campus and where the business is not necessarily located on-campus. The user enters the distance from the location, step 340, and is asked to approve the total quantity of addresses within the specified range, step 350. If not approved the system returns to step 330. Once approved, the user is presented with a calculation of the total maximum cost which would be incurred if the order is confirmed, step 400.

In addition to mere proximity, the business may configure a list based upon state, county, zip or other codes.

However, a more sophisticated manner for selecting addresses is available using the demographic data maintained and/or accessible by the system as an address source. This aspect of the system is useful where for example, the user wishes to select not only individuals within ten miles from the business's address, but also only apartments and not single family homes.

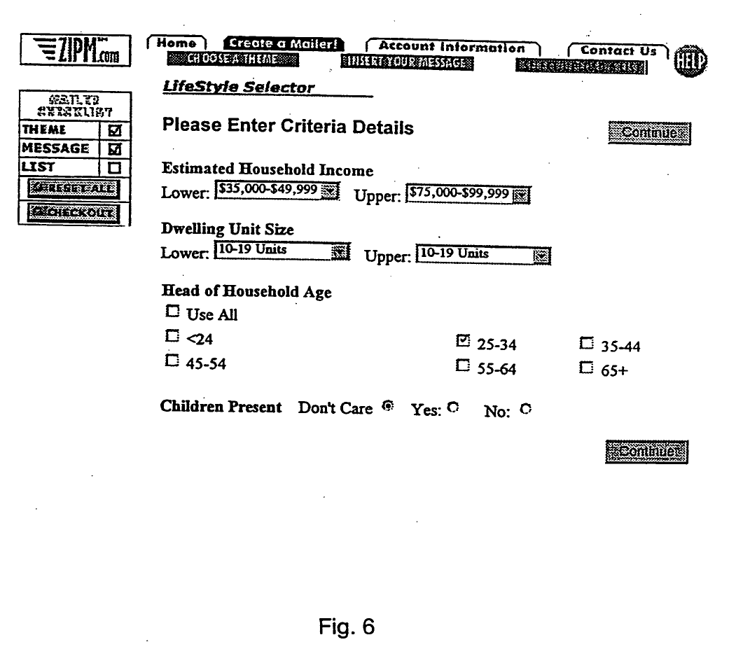

The user may thus access the on-line demographic database, step 360. The user will be presented with various choices corresponding to the different demographic criteria maintained by the system as illustrated in FIG. 6. The user may select one or more of the variables and identify the particular demographic characteristics to be used in searching the database toward selecting addressees for the direct mail piece, step 370. Once identified the system will search the database for matches, step 380 and will be asked to approve the total quantity of addresses returned, step 390. If not approved the system returns to step 370. Once approved, the user is presented with a calculation of the total maximum cost which would be incurred if the order is confirmed, step 400.

A number of demographic options may be made available to the user, so as to permit the user to select addressees by income, by children in the family and the like. Through this manner, for example, a business selling baby products, may, if so desired, exclude from the list of potential recipients, addresses of single person households, or alternatively may target only those families with children. The user may select an affinity list such as a list of people who subscribe to a certain magazine. The user may create an address list using demographic data maintained by the system.

For example, a pizzeria may decide to offer a special on gourmet pizzas and accordingly may wish to target a certain group of potential customers. The business may target people who are most likely to order gourmet pizzas and to that end the business may define a mailing list comprised of people who subscribe to cooking magazines. To accomplish the same end the business may use the demographic data criteria to select households in certain income ranges, or without children on the assumption that children do not like such pizzas. The business may further wish to define a mailing list comprised of addresses within a certain neighborhood who are believed most likely to order such goods. The demographic choices may include such factors as income, size of family, ownership of cars, homes, likes, dislikes and other data within the system database.

Each of the foregoing alternatives generate a user defined mailing list by accessing databases and the results may be maintained by the system for later use in connection with another mailing.

Once a mailing list has been defined, the user may be given the option to execute a rolling mailing campaign whereby the system will, for example, randomly select one thousand addresses within address list and generate direct mail pieces addressed to those addresses for mailing during a first mailing. The system may further generate additional randomly selected groups of one thousand addresses from within the address list for mailing during subsequent periods of time until such time as all of the addresses within the address list have been selected—all without duplication.

Once the direct mail piece has been composed, once the address list has been selected, and once the user has approved the total maximum cost for the mailing, step 410, the user is prompted to specify a mailer dispatch date, step 420. The dispatch date is the date upon which the printed direct mail pieces will be delivered to the post office for mailing. At that point the user is asked to confirm the order, step 430 after which the user exits the system having created, addressed and dispatched a direct mail piece entirely on-line via the Internet.

The present system will then automatically cause the direct mail pieces to be printed at a printer located proximate the system or at remotely located printer. The system prints the direct mail pieces in a pre-sorted fashion in order to take advantage of the lowest available mailing rates offered by the postal service. The direct mail pieces are then forwarded by the proprietor of the system to the postal service for delivery to the recipient.

In view of the on-line computerized designing, addressing, printing and mailing of direct mail pieces, the user has access to an order list as well as deadline lists such that orders may placed up to the very last minute in order to achieve the desired delivery dates—as may be desirable for a business who wishes to target college students who may be in town on vacation. Not only may orders be placed up to the very last minute to meet a given delivery date, but orders may also be recalled and or modified up to the point at which they are released for production—without requiring the user to interact with creators, copyrighters, printers, mail houses and the like.

The foregoing description and drawings merely explain and illustrate the invention and the invention is not limited thereto except insofar as the appended claims are so limited, inasmuch as those skilled in the art, having the present disclosure before them will be able to make modifications and variations therein without departing from the scope of the invention.

What is claimed is:

1- A method for creating a custom designed direct mail advertisement and designating recipients thereof via the Internet, said method comprising:
logging on to a web site via the Internet;
selecting from among one or more pre-defined designs a design for the front side of a direct mail advertisement;
selecting from among one or more predefined templates a design for the back side of a direct mail advertisement;
specifying the text that appears on the back side of a direct mail advertisement;
specifying one or more criteria that define the intended recipient class for the direct mail advertisement;
compiling the list of recipients for the direct mail advertisement corresponding to the specified criteria; and
electronically transmitting data files comprising the design of the front and back sides of the direct mail advertisement and the list of recipients toward printing pre-addressed individual copies of the custom designed direct mail advertisement for subsequent mailing to the intended recipients thereof.

2- The invention according to claim 1 wherein the invention further includes the step of selecting a theme for the direct mail piece from one or more themes with theme having associated therewith one or more pre-defined designs.

3- The invention according to claim 1 wherein the step of specifying one or more criteria that define the intended recipient class for the direct mail advertisement comprises the step of entering the name and addresses for each intended recipient of the direct mail piece.

4- The invention according to claim 1 wherein the step of specifying one or more criteria that define the intended recipient class for the direct mail advertisement comprises the step of specifying a starting address and a distance therefrom toward identifying the intended recipients of the direct mail piece.

5- The invention according to claim 4 wherein the step of specifying one or more criteria that define the intended recipient class for the direct mail advertisement further comprises the step of searching a database corresponding to names and addresses using the specified criteria toward identifying the name and address for each intended recipient of the direct mail piece.

6- The invention according to claim 1 wherein the step of specifying one or more criteria that define the intended recipient class for the direct mail advertisement comprises the step of entering one or more demographic criteria associated with the names and addresses maintained by a database toward identifying intended recipients of the direct mail piece.

7- The invention according to claim 1 wherein the step of specifying one or more criteria that define the intended recipient class for the direct mail advertisement comprises the step of transferring a pre-existing database list of names and addresses for the intended recipients of the direct mail piece.

8- The invention according to claim 1 wherein the invention further includes the step of providing to the user the maximum cost of creating, producing and mailing the direct mail piece to each member of the intended recipient class

9- A method for creating a custom designed direct mail advertisement and designating recipients thereof via the Internet, said method comprising:
logging on to a web site via the Internet;
selecting from among one or more pre-defined designs a design for the front side of a direct mail advertisement;
selecting from among one or more predefined templates a design for the back side of a direct mail advertisement;
specifying the text that appears on the back side of a direct mail advertisement;
specifying one or more criteria that define the intended recipient class for the direct mail advertisement;
compiling the list of recipients for the direct mail advertisement corresponding to the specified criteria by searching a database for names and addresses that match the specified criteria; and
transmitting the design of the front and back sides of the direct mail advertisement and the list of intended recipients of same toward for printing pre-addressed individual copies of the designed direct mail advertisement for subsequent mailing to the intended recipients thereof.
